(19) United States
(12) Patent Application Publication
(10) Pub. No.: US 2011/0214162 A1
(43) Pub. Date: Sep. 1, 2011

(54) METHOD AND APPARTUS FOR PROVIDING COOPERATIVE ENABLEMENT OF USER INPUT OPTIONS

(75) Inventors: Jorg Brakensiek, Mountain View, CA (US); Raja Bose, Mountain View, CA (US)

(73) Assignee: Nokia Corporation

(21) Appl. No.: 12/713,780

(22) Filed: Feb. 26, 2010

(51) Int. Cl. G06F 21/00

(52) U.S. Cl. 726/4

(57) ABSTRACT

An apparatus for providing cooperative enablement or disablement of user input options may include at least one processor and at least one memory including computer program code. The at least one memory and the computer program code may be configured, with the processor, to cause the apparatus to perform at least receiving a first indication identifying any user input option to be enabled or disabled based on context information associated with a local device, receiving a second indication of any user input option to be enabled or disabled based on context information associated with a remote device, and providing enablement or disablement of user input options of the local device based on the first indication and the second indication. A corresponding method and computer program product are also provided.

### TECHNOLOGICAL FIELD

Embodiments of the present invention relate generally to inter-device communications technology and, more particularly, relate to an apparatus and method for providing cooperative enablement of user input options.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. In order to provide easier or faster information transfer and convenience, telecommunication industry service providers are developing improvements to existing networks. In this regard, wireless communication has become increasingly popular in recent years due, at least in part, to reductions in size and cost along with improvements in battery life and computing capacity of mobile electronic devices. As such, mobile electronic devices have become more capable, easier to use, and cheaper to obtain. Due to the now ubiquitous nature of mobile electronic devices, people of all ages and education levels are utilizing mobile terminals to communicate with other individuals or contacts, receive services and/or share information, media and other content. Moreover, for many individuals, mobile electronic devices such as portable digital assistants (PDAs), pagers, mobile televisions, mobile telephones, gaming devices, laptop computers, cameras, video recorders, audio/video players, radios, global positioning system (GPS) devices, become heavily relied upon for work, play, entertainment, socialization and other functions. Thus, many people are very connected to their respective mobile electronic devices.

Given the personal connection many people have to their mobile electronic devices, and their ability and penchant for having such devices with them, it is not uncommon for many people to prefer to use their personal mobile electronic device as a source for information and/or services, even in situations where another less flexible device is already in place to provide a particular type of information and/or service.

Accordingly, it may be desirable to provide an improved mechanism by which a mobile electronic device or mobile terminal may interface with other devices.

### BRIEF SUMMARY OF EXAMPLE EMBODIMENTS

A method and apparatus are therefore provided that may enable the provision of cooperative enablement of user input options for a mobile terminal of the user and some other remote device or remote environment (e.g., a remote display stream). In this regard, for example, the mobile terminal of a user and the remote environment may exchange information to identify keys, or other user input mechanisms that may be enabled or disabled at each respective device or environment. Thus, for example, a white list information defining useable input options and black list information defining input options that are to be disabled may be exchanged between the mobile terminal and the remote environment to provide cooperative enablement of user input options.

In one example embodiment, a method of providing cooperative enablement of user input options is provided. The method may include receiving a first indication identifying any user input option to be enabled or disabled based on context information associated with a local device, receiving a second indication of any user input option to be enabled or disabled based on context information associated with a remote device, and providing enablement or disablement of user input options of the local device based on the first indication and the second indication.

In another example embodiment, a computer program product for providing cooperative enablement of user input options is provided. The computer program product may include at least one computer-readable storage medium having computer-executable program code instructions stored therein. The computer-executable program code instructions may include program code instructions for receiving a first indication identifying any user input option to be enabled or disabled based on context information associated with a local device, receiving a second indication of any user input option to be enabled or disabled based on context information associated with a remote device, and providing enablement or disablement of user input options of the local device based on the first indication and the second indication.

In another example embodiment, an apparatus for providing cooperative enablement of user input options is provided. The apparatus may include at least one processor and at least one memory including computer program code. The at least one memory and the computer program code may be configured, with the processor, to cause the apparatus to perform at least receiving a first indication identifying any user input option to be enabled or disabled based on context information associated with a local device, receiving a second indication of any user input option to be enabled or disabled based on context information associated with a remote device, and providing enablement or disablement of user input options of the local device based on the first indication and the second indication.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for providing cooperative enablement of user input options according to an example embodiment of the present invention;

FIG. 3 illustrates a block diagram showing an incremental update procedure for two devices operating in accordance with an example embodiment of the present invention;

FIG. 4 illustrates an example of a touch interface that may be associated with a mobile terminal while the mobile terminal is in communication with a remote environment in the form of a car head unit according to an example embodiment of the present invention;

FIG. 5, which includes FIGS. 5A and 5B, shows an example of a speller layout for a car head unit to illustrate operation of an example embodiment in connection with FIGS. 6 and 7;

FIG. 6 illustrates an example communication architecture for communication between an example mobile terminal and the speller of a car head unit according to an example embodiment of the present invention;

FIG. 7 describes a process for speller optimization involving reducing the keys available to the speller according to an example embodiment of the present invention; and

FIG. 8 illustrates a flowchart of a method of providing cooperative enablement of user input options in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a physical storage medium (e.g., volatile or non-volatile memory device), can be differentiated from a “computer-readable transmission medium,” which refers to an electromagnetic signal.

As indicated above, mobile terminals are becoming very common and very personal to their respective users. As such, the user interface options offered by a mobile terminal may often be very familiar to their respective users. Moreover, user interface options offered by the mobile terminal may in some cases be more robust and more flexible than the interfaces offered by certain remote environments (although the opposite may apply in some cases). Accordingly, given the opportunity to interact with a remote environment that can communicate with the mobile terminal to enable control functions for the remote environment to be provided via the mobile terminal's user interface, many users may prefer to engage the user interface of the mobile terminal. However, there may be certain context rules that would impact operability of certain user input options of the remote environment for safety, regulatory or other reasons. As such, it may be desirable to impart such context rules also to the mobile terminal in order to satisfy any rules that may apply. For example, a GPS system of a car may actually be placed in communication with a mobile terminal such that the mobile terminal user interface may be used to implement certain functions of the GPS system. However, the car may (by virtue of safety requirements) have limited access to certain user input options (e.g., entering destination names or addresses via a speller device) when the car is in motion. Thus, it may be desirable to pass those access limitations on to the mobile terminal to ensure that the safety requirements cannot be undermined.

Some embodiments of the present invention may provide a mechanism by which improvements may be experienced in relation to the interoperability of mobile terminals with remote environments. In this regard, for example, a mobile terminal may be placed in communication with a remote device or environment, and the mobile terminal and the remote environment may exchange information on user input options that are to be enabled and disabled based on the current context of at least one of the devices. Thus, for example, in situations where the user interface of the mobile terminal is being used to interface with the remote environment (or vice versa), the enabled or disabled user input options that apply to one device may also be shared with the other device.

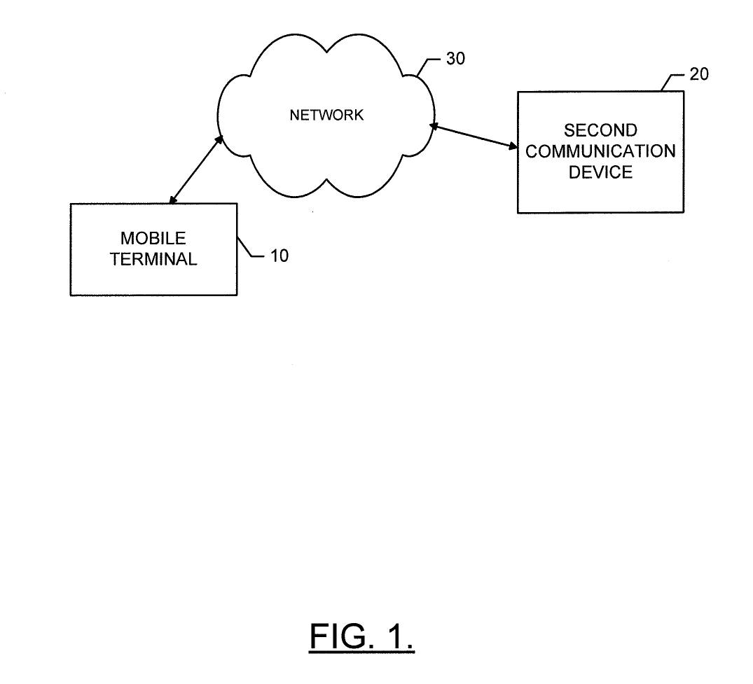

FIG. 1 illustrates a generic system diagram in which a device such as a mobile terminal 10, which may benefit from embodiments of the present invention, is shown in an example communication environment. As shown in FIG. 1, an embodiment of a system in accordance with an example embodiment of the present invention may include a first communication device (e.g., mobile terminal 10) and a second communication device 20 capable of communication with each other. In an example embodiment, the mobile terminal 10 and the second communication device 20 may be in communication with each other via a network 30. In some cases, embodiments of the present invention may further include one or more network devices with which the mobile terminal 10 and/or the second communication device 20 may communicate to provide, request and/or receive information.

It should be noted that although FIG. 1 shows a communication environment that may support client/server application execution, in some embodiments, the mobile terminal 10 and/or the second communication device 20 may employ embodiments of the present invention without any network communication, but instead via a direct communication link between the mobile terminal 10 and the second communication device 20. As such, for example, applications executed locally at the mobile terminal 10 and served to the second communication device 20 via a direct wired or wireless link may also benefit from embodiments of the present invention. However, it should be noted that communication techniques such as those described herein can be used not only in embedded devices, but in desktops and servers as well.

The network 30, if employed, may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. One or more communication terminals such as the mobile terminal 10 and the second communication device 20 may be in communication with each other via the network 30 or via device to device (D2D) communication and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and/or the second communication device 20 via the network 30. By directly or indirectly connecting the mobile terminal 10 and/or the second communication device 20 and other devices to the network 30 or to each other, the mobile terminal 10 and/or the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not specifically shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, the first communication device (e.g., the mobile terminal 10) may be a mobile communication device such as, for example, a PDA, wireless telephone, mobile computing device, camera, video recorder, audio/video player, positioning device (e.g., a GPS device), game device, television device, radio device, or various other like devices or combinations thereof The second communication device 20 may also be a mobile device such as those listed above or other mobile or embedded devices, but could also be a fixed communication device in some instances. For example, the second communication device 20 could be an in-car navigation system, a vehicle entertainment system or any of a number of other remote environments with which the mobile terminal 10 may communicate.

In an example embodiment, the network 30 may provide for virtual network computing (VNC) operation between the mobile terminal 10 and the second communication device 20. As such, for example, the mobile terminal 10 may serve as a VNC server configured to provide content originally executed or accessed by the mobile terminal 10 to the second communication device 20 acting as a VNC client (or vice versa). A VNC protocol such as RFB (remote frame buffer) or another protocol for enabling remote access to a graphical user interface may be utilized to provide communication between the mobile terminal 10 and the second communication device 20. Moreover, according to one example, the second communication device 20 may be a vehicle entertainment system (e.g., one or more speakers and one or more displays mounted in a head rest, from the ceiling, from the dashboard, or from any other portion of a vehicle such as an automobile).

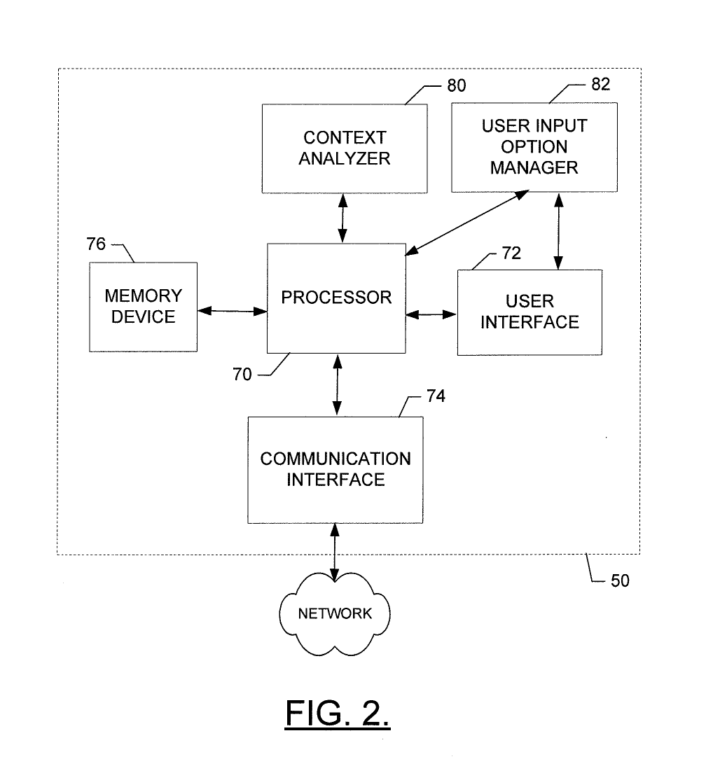

In an example embodiment, the mobile terminal 10 may be configured to include or otherwise employ an apparatus according to an example embodiment of the present invention. FIG. 2 illustrates a schematic block diagram of an apparatus for providing cooperative enablement of user input options according to an example embodiment of the present invention. An example embodiment of the invention will now be described with reference to FIG. 2, in which certain elements of an apparatus 50 for providing cooperative enablement of user input options are displayed. The apparatus 50 of FIG. 2 may be employed, for example, on a communication device (e.g., the mobile terminal 10 and/or the second communication device 20) or a variety of other devices, such as, for example, any of the devices listed above. However, it should be noted that the components, devices or elements described below may not be mandatory and thus some may be omitted in certain embodiments. Additionally, some embodiments may include further components, devices or elements beyond those shown and described herein.

Referring now to FIG. 2, the apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., an AP or other network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control a context analyzer 80 and a user input option manager 82. The context analyzer 80 and the user input option manager 82 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the context analyzer 80 and the user input option manager 82, respectively, as described herein. Thus, in examples in which software is employed, a device or circuitry (e.g., the processor 70 in one example) executing the software forms the structure associated with such means.

In an example embodiment, as indicated above, a remote frame buffer copying process may be employed to copy frames from the content at the mobile terminal 10 in a first frame buffer over to a second frame buffer at the second communication device 20 for rendering thereat. Likewise, the remote frame buffer copying process may be employed to copy frames from the content at the second communication device 20 in the second frame buffer over to the first frame buffer at the mobile terminal 10 for rendering thereat. In addition to enabling presentation of content or data generated at one device to the other device, some embodiments of the present invention may also provide for the exchange of information on enabled and/or disabled user input functions, for example, based on context. As such, the context analyzer 80 (an instance of which may be included on each device when an embodiment of the apparatus 50 is included on both the mobile terminal 10 and the second communication device 20) may provide an analysis of context for use in determining which user input options are to be enabled and/or disabled and the user input option manager 82 may be employed to share information between the devices to reconcile user input options that are to be provided based on the context.

The context analyzer 80 may be configured to determine the context environment of a device such as the mobile terminal 10 (or the second communication device 20). In some embodiments, the context determination may be generic (e.g., moving or stationary). However, in other embodiments, the context determination may be more specific (e.g., the device being in an automotive context, movement of the device above or below a predetermined speed, the device being in a particular location, etc.). The context analyzer 80 may also be in communication with a movement or other environmental sensor of either the mobile terminal 10 or the second communication device 20 (e.g., a GPS device, cell-tower tracking sensor, or other positioning sensor) in order to receive context information related to location and/or motion (including speed in some cases).

Context information determined by the context analyzer 80 may be determined based on analysis accomplished on the basis of either static or dynamic settings. In this regard, for example, static user settings input by the user may be utilized to determined context information. For example, if the user starts a copying process with regard to frame buffer data, a static user setting may determine by default that the initiation of the copying process confirms an automotive context for the apparatus 50. Dynamic user settings may also be used whereby the user sets a configuration indicating that the user is in a particular context (e.g., via selection from a list of potential contexts or selection of one particular context (e.g., a vehicle context) with which an embodiment is configured to operate). In an example embodiment configured to operate in a vehicle context, if the apparatus 50 is determined to be in the vehicle context, embodiments of the present invention may select content for copying to the remote device based on the type of content and based on the rule set governing presentation of content via a vehicle entertainment system. For example, if local rules or regulations provide that a particular portion of the console display of an automobile not be enabled to provide specific user input options or other distracting information to the user above a particular speed, the context information may be indicative of whether the apparatus 50 is in a vehicle context and, in this example, whether the speed is above or below the particular speed. The context information may then be provided to the user input option manager 82 in order for the user input option manager 82 to determine whether some portion (or all) of the user input options should be blocked from provision to the mobile terminal 10 and/or the second communication device 20.

The user input option manager 82 may be configured to recognize the user input space available for the devices in communication. For example, the user input option manager 82 may be aware of the keys (e.g., including soft keys or hard keys) that are physically or virtually available in each operating mode of devices with which the user input option manager 82 may be associated. Thus, the user input option manager 82 may be aware of all text-based input and functional inputs that are capable of being entered through a user keyboard, mouse, joystick, or via cursor other selection. The user input option manager 82 may also be aware of all types of input that can be entered by a user through a touch screen. For example, the selection of a text character by selecting a touch screen portion corresponding to the respective character or selection of a functional icon at a particular portion of a touch screen display. In some embodiments, the user input option manager 82 may also be configured to recognize touch gestures that may be entered through a touch screen as well. For example, pinch-zoom and other gestures that are available via a mobile device or a remote environment may be known to the user input option manager 82. Likewise, visual gestures that are available as potential user interface options may also be managed by the user input option manager 82. Thus, for example, if a remote environment or mobile terminal has the capability to utilize a camera to view detectable gestures that may be associated with execution of corresponding functions when such gestures are detected, the user input option manager 82 may manage such user input options as described below. The same applies to voice commands. In this regard, any recognizable voice command or other spoken input that may be associated with execution of corresponding functions when such commands or inputs are detected may also be managed by the user input option manager 82 as described below. Thus, any interactive interface (e.g., including at least visual, audible, touch based or key based interfaces) may be managed by the user input option manager 82.

In an example embodiment, the user input option manager 82 may manage user input options using a set of lists and sequential updates to such lists in which the lists define enabled or disabled user input options. In some embodiments, a set of enabled user input options may be considered to be a white list and a set of disabled user input options may be considered to be a black list. As such, the user input option manager 82 may provide for the generation and/or updating of white lists and black lists. In particular, the user input option manager 82 may generate and update a local white list and a local black list for the device with which the user input option manager 82 is associated, and the user input option manager 82 may reconcile the local white list and black list with a corresponding received remote white list and black list provided by the user input option manager of another device. Thus, for example, if the mobile terminal 10 is in communication with the second communication device 20, the user input option manager 82 may determine a local white list and a local black list for user input options of the mobile terminal 10 based on the mobile terminal's current context (as provided by the context analyzer 80) and the user input option manager 82 may also receive information indicating the remote white list and the remote black list of the second communication device 20. The user input option manager 82 may then reconcile the local and remote white and black lists to enable or disable user input options accessible via the mobile terminal 10 accordingly. In reconciling white lists and black lists, the user input option manager 82 may prioritize black listings over white listings. For example, if a particular key is white listed by one device, but black listed by the other device, the particular key will be black listed by the user input option manager 82 to prevent use of the key in the current context since it can be assumed that there is some desirable reason for inhibiting usage of the key under the current circumstances.

Accordingly, the user input option manager 82 may generate black list information and white list information for transmission between the mobile terminal 10 and the second communication device 20. In some cases, the black list information may be a complete list of black listed (or disabled) user input options and the white list information may be a complete list of white listed (or enabled) user input options. However, the black list information and the white list information need not be all inclusive. As such, for example, the black list information and/or the white list information could instead merely provide a list of changes since a previous reporting. Thus, the black list information could include only changes to the black list (e.g., ABL and AWL).

In some embodiments, the user input space may be divided by input option type or class and white list information and black list information may be provided on a class-wise basis. For example, the white list information may include a touch based white list and black list, a key based white list and black list, etc. In some embodiments in which the white list information and black list information provide a corresponding white list and black list, the lists may be classified as being empty, full or partial. An empty black or white list may not include any elements. Thus, for example, an empty black list may imply that all input options are enabled or turned on. Meanwhile, an empty white list may imply that all input options are disabled or turned off. A full white or black list may include all possible values for the corresponding input option class. Accordingly, the presentation of a full or empty set of a white list may necessarily imply a corresponding condition for the black list of empty or full, respectively. As an example, for a particular context, a full voice input white list may be provided and an empty key input white list may be provided to thereby imply an empty voice input black list and a full key input black list.

A partial white list or black list may include a subset of all of the possible values for the corresponding input option class (e.g., a subset of the full version). In some embodiments, partial white lists or black lists may be exchanged to communicate updates to prior lists. As such, it may be common for full white lists and/or black lists to be exchanged during connection establishment and partial lists to be exchanged thereafter to communicate changes to the respective lists.

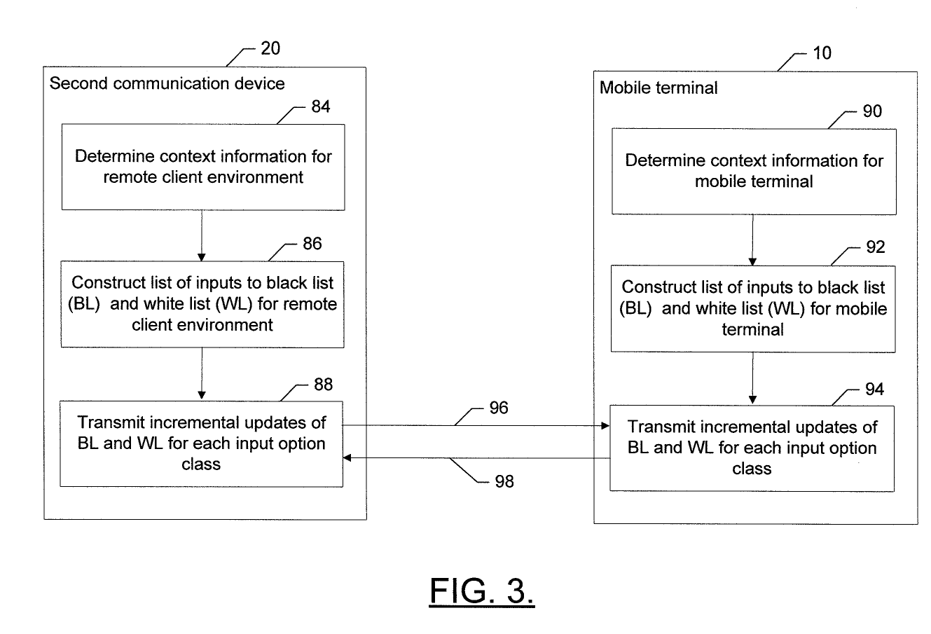

In an example embodiment, when the mobile terminal is initially connected to the remote environment (e.g., the second communication device 20), the mobile terminal 10 and the second communication device may exchange full white lists for all the input option classes supported by each respective device. The full white lists may also be exchanged any time thereafter. For example, full white lists may be exchanged on-demand during the lifetime of the connection or in response to certain changes in context. However, in alternative cases, possible input options for each input option class may be known by respective devices beforehand (e.g., due to standardization or previous communication). In such cases, no initial exchange of full lists may be performed. Subsequent updates of white list information and black list information corresponding to each input option class may then be performed incrementally in relation to values that are changed. Thus, minimal information may actually need to be transmitted between devices. FIG. 3 illustrates a block diagram showing an incremental update procedure for two devices (e.g., the mobile terminal 10 and the second communication device 20) operating in accordance with an example embodiment.

As shown in FIG. 3, the second communication device 20 may initially determine context information for itself at operation 84 (e.g., via a local instance of the context analyzer 80). The second communication device 20 may then generate black list (BL) and white list (WL) information based on the determined context information at operation 86 (e.g., via a local instance of the user input option manager 82). Incremental updates to the BL and WL information may then be transmitted from the second communication device 20 to the mobile terminal 10 at operation 88. The transmission of BL and WL information may occur either at routine intervals, at discrete intervals, or in response to specific stimuli such as, for example, changes in context (or at least changes in context that result in a corresponding change in BL or WL information). Similarly, the mobile terminal 10 may initially determine context information for itself at operation 90 (e.g., via a local instance of the context analyzer 80). The mobile terminal 10 may then generate black list (BL) and white list (WL) information based on the determined context information at operation 92 (e.g., via a local instance of the user input option manager 82). Incremental updates to the BL and WL information may then be transmitted to the second communication device 20 from the mobile terminal 10 at operation 94. The transmission of BL and WL information may occur either at routine intervals, at discrete intervals, or in response to specific stimuli such as, for example, changes in context (or at least changes in context that result in a corresponding change in BL or WL information). The BL and WL information transmitted from the second communication device 20 to the mobile terminal 10 is indicated at arrow 96 and may include BL and WL information on a class by class basis for each respective input option class (or at least those classes that have changes associated therewith). The BL and WL information transmitted to the second communication device 20 from the mobile terminal 10 is indicated at arrow 98 and may also include BL and WL information on a class by class basis for each respective input option class (or at least those classes that have changes associated therewith).

As discussed above, it is not necessary that both a white list and a black list be transmitted during every update. Rather, in some instances, only a white list or a black list may be transmitted and any values which are present in an incremental update of a black list may be removed by the recipient from its corresponding white list. Similarly any values which are present in an incremental update of a white list may be removed by the recipient from its corresponding black list. For example, if an existing black list and an existing white list for a specific input class at the remote environment are denoted by BL and WL, respectively, and the mobile device sends an incremental update for the black list (BL1) and the white list (WL1) to the remote environment, then the remote environment may indicate a new black list reflecting that BL=(BL\WL1)U(BL1), and the remote environment may indicate a new white list reflecting that WL=(WL\BL1)U(WL1).

As also discussed above, the white list and black list information provided may be used to enable or disable corresponding user input options. With respect to disabling hard keys, it may be easy to appreciate that the functionality associated with a respective key may simply be removed such that, for example, no effect is realized when the corresponding key is pressed or selected. For soft keys, disabled keys may simply not be presented or may be obscured from view. A similar removal of or obscuring of certain options may also be provided for touch displays. However, certain functionalities may also be removed for touch displays that don't necessarily manifest with a corresponding visible indication. For example, a particular touch gesture may be ineffective although there may not be a visible indication that such gesture is not effective. However, in other instances, whenever some disabled functionality is requested (or simply when some inhibited functionality is present) an icon or warning may be provided to the user for explanation. For gesture or voice commands, disabling of certain input options may simply render the corresponding input options ineffective.

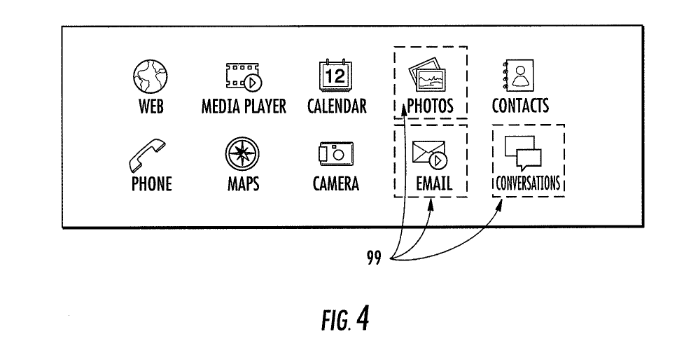

FIG. 4 illustrates an example of a touch interface that may be associated, for example, with the mobile terminal 10 while the mobile terminal 10 is in communication with a remote environment in the form of a car head unit (e.g., acting as the second communication device 20). The car head unit may require that certain functionality be disabled to avoid driver distraction when the car is in motion. As such, some functionality may be added to a black list of the car head unit and communicated to the mobile terminal 10 according to the example described above in connection with FIG. 3. The mobile terminal 10 may receive the black list information provided by the car head unit and disable the corresponding black listed items. In the example of FIG. 4, icons associated with applications for photo viewing, email and conversation have been disabled as indicated by disabled touch screen areas 99. In this example, the lists may include rectangular coordinates describing a screen area of the form (X coordinate, Y coordinate, width, height) that are to be disabled. For example, in FIG. 4, black list information may be provided in the form BL={(400, 50, 100, 100), (400, 200, 100, 100), (550, 200, 150, 100)} and WL=BL′ (complement of BL). The mobile terminal 10 may then disable the corresponding icons at each respective location to prevent driver distraction and /or enforce safety regulations by preventing the user from activating the application icons placed in the corresponding touch areas. When the car is stationary and/or the engine is switched off, the car head unit may detect a change in its context and send a white list containing the touch areas described above in order to indicate to the mobile terminal 10 that the corresponding touch areas may be activated again.

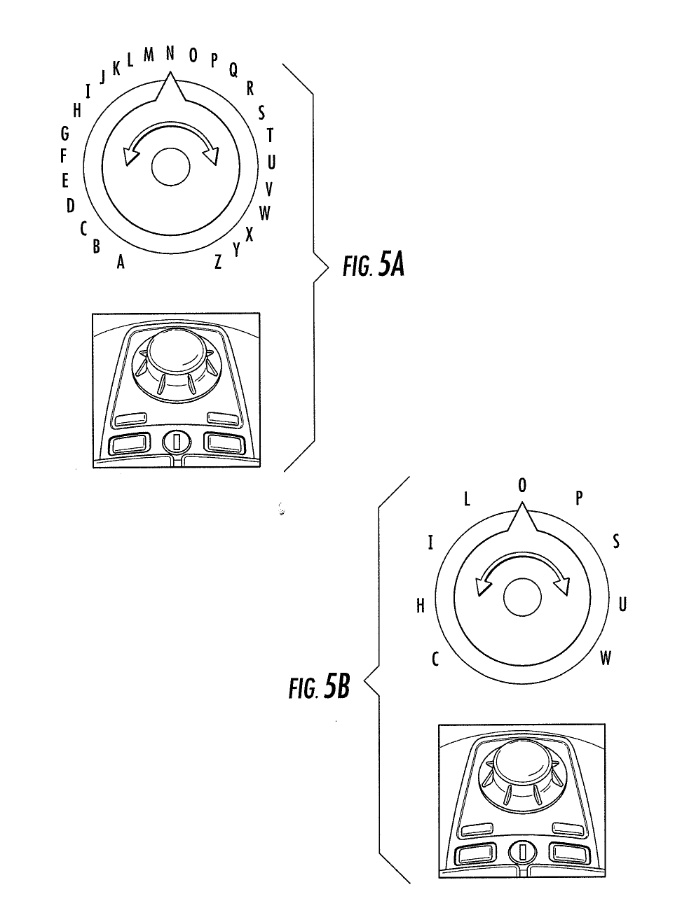

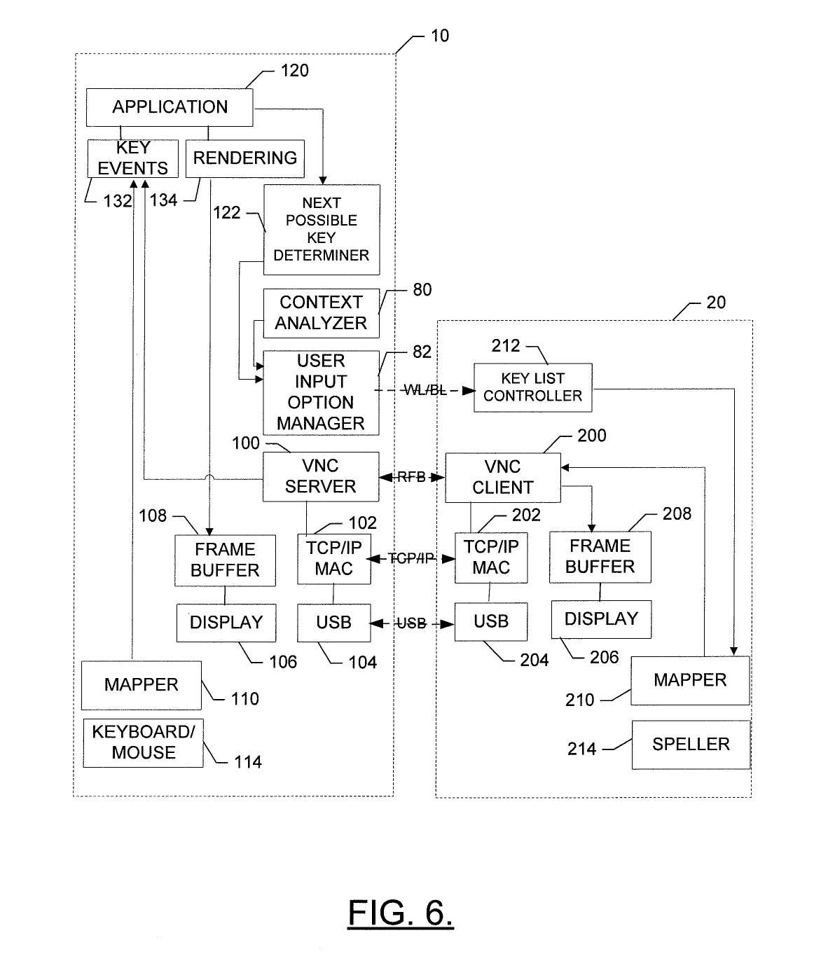

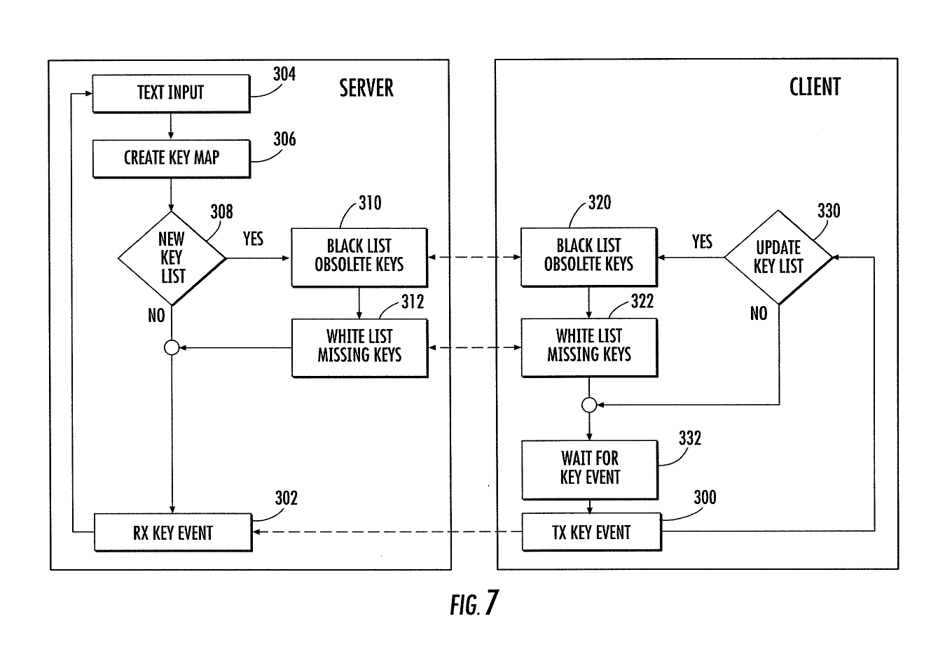

FIG. 5, which includes FIGS. 5A and 5B, shows an example of a speller layout for a car head unit to illustrate operation of an example embodiment in connection with FIGS. 6 and 7. FIG. 6 illustrates an example communication architecture for communication between an example mobile terminal and the speller of a car head unit (e.g., acting as the second communication device 20). FIG. 7 describes a process for speller optimization involving reducing the keys available to the speller according to an example embodiment.

As shown in FIG. 5, a speller 214 may be associated with the car head unit as a popular user input mechanism for entering text characters in an automotive environment. As shown in FIG. 5A, the speller 214 may typically have an array of characters displayed around a rotatable selection mechanism. By rotating in one direction or another, a specific character may be the object of a pointer to enable selection of the corresponding character, if desired by the user. As shown in FIG. 5A, the speller 214 may initially provide all possible characters as options (e.g., all twenty-six letters of the alphabet). However, by utilizing the black listing and white listing capabilities associated with an embodiment of the present invention in conjunction with a mobile terminal application for determining probable next possible keys based on currently entered keys, the simplified speller with reduced options shown in FIG. 5B may be provided. The example architecture of FIG. 6 may be used to provide the simplified speller according to an example embodiment. Notably, the lines connecting certain elements of FIG. 6 are not illustrative of the only connections between components of the device illustrated. Instead, the lines connecting certain elements of FIG. 6 are only used to exemplify specific connections of interest in relation to carrying out one example embodiment of the present invention.

As shown in FIG. 6, an embodiment of the present invention may include a first device (e.g., the mobile terminal 10) and a second device (e.g., the second communication device 20) capable of communication with each other. As shown in FIG. 6, the mobile terminal 10 may act as or otherwise include a VNC server 100 while the second communication device 20 acts as or otherwise includes a VNC client 200. The VNC server 100 and the VNC client 200 may communicate with each other via a protocol such as RFB. Other communication may be provided via TCP/IP (transport control protocol/Internet protocol) or USB using TCP/IP media access control (MAC) modules (e.g., TCP/IP MAC module 102 and TCP/IP MAC module 202), TCP/IP connection over USB or USB modules (e.g., USB module 104 and USB module 204) at each device, respectively. In an example embodiment, each of the first device and the second device may have a display (e.g., display 106 and display 206) that may display content in a corresponding frame buffer (e.g., frame buffer 108 and frame buffer 208). The first and second devices may also each have their own respective user interfaces (e.g., keyboard/mouse 114 and speller 214) to facilitate the receipt of user instructions. In some embodiments, the first and second devices may each also include corresponding mapping devices (e.g., mapper 110 and mapper 210) for mapping input options between the keyboard/mouse 114 to corresponding input options of the speller 214.

As described above, the frame buffer 108 of the first device may have content to be copied to the frame buffer 208 of the second device in accordance with an example embodiment. The content may be produced by or in association with a particular application (e.g., application 120) that may run on the first device. In an example embodiment, the first device may include a key event module 132 and a rendering module 134.

The key event module 132 and the rendering module 134 may each be any means such as a device or circuitry operating in accordance with software or otherwise embodied in hardware or a combination of hardware and software thereby configuring the device or circuitry to perform the corresponding functions of the key event module 132 and the rendering module 134, respectively, as described herein. The key event module 132 may be configured to receive user interface events (e.g., from the keyboard/mouse 114) and input from the VNC server 100. Meanwhile, the rendering module 134 may be configured to provide content received to the frame buffer 108 for potential copying to the frame buffer 208 via VNC. In this regard, for example, after receiving content from the rendering module 134, the content may be provided to the VNC server 100, which may provide selected portions of the content to the VNC client 200. Alternatively, as indicated above, the VNC server 100 may provide the content along with indications regarding which selected portions are to be displayed at the second device. Notably, the frame buffer 108 (or frame buffer 208) may be embodied as a physical frame buffer or a virtual frame buffer.

According to an example embodiment, the application 120 may include or otherwise be associated with a functionality for determining next possible keys based on entered text already provided (e.g., next possible key determiner 122). Based on text already entered, the next possible key determiner 122 may be able to identify specific keys that are no longer possible entries. The user input option manager 82 may utilize the identity of keys that are no longer possible entries in order to enter such keys into a black list. The black list may then be provided to the second communication device 20 to a key list controller 212, which may provide indications to the mapper 214 to identify keys that are no longer options so that, for example, the updated speller display of FIG. 5B may be provided based on the black listed keys identified by the next possible key determiner 122 of the mobile terminal 10. In this regard, the application 120, and particularly the next possible key determiner 122 associated with the application 120, applies text completion methods to a partial user entry and, based on the partial user entry, determines which characters are possible next characters. In the example of FIG. 5B, the white list may include WL={L, 0, P, S, U, W, C, H, I, L} and the black list may include BL={A, B, D, E, F, G, . . . , Z}. When the updated white list and black list are transmitted to the car head unit, the head unit can utilize them to display only those character choices which are white listed thereby enabling the user to efficiently input text using the multi-functional knob without having to rotate through the entire alphabet every time.

In some embodiments, the application 120 can derive context information also from current location information, e.g. a navigation application may have a list of all available city names in a specific region/country and can figure out the expected next letter, based on the previously received ones. For example, embodiments of the present invention may enable the speller to consider, while entering a city name, that there are only a reduced number of possible combinations left, while entering the letters. For example, after entering BERL there may be only “I” (for Berlin) or “E” (for Berleburg) possible. Therefore the user would not need to select between all possible alphanumeric options.

FIG. 7 illustrates several aspects of the scenario above in a functional block diagram. In this regard, as shown at operation 300, a key event at the client device (e.g., the head unit) may be transmitted to the server (e.g., the mobile terminal 10) and received at operation 302. The received key event may then be recognized as a text input at operation 304 to be mapped (e.g., via the mapper 110) at operation 306 to determine whether a new key list is needed at operation 308. If a new key list is needed, obsolete keys are blacklisted at operation 310 and other keys are white listed at operation 312. If no new key list is needed, then a next key event may be awaited for re-evaluation. The black listed and white listed keys are communicated to the client and received at operation 320 and 322, respectively. When the key event is received at the client device, the client device may also evaluate whether to update its key list at operation 330. After any updates to the key list are made or changes to the black list and white list are made, the client may wait for another key event at operation 332.

In some cases, although embodiments of the present invention may be employed to enforce safety regulations in a context-aware manner by enabling/disabling specific functional keys, for example, when a vehicle is in motion, the operation of example embodiments may be limited in some cases. For example, it may not be possible to black list keys or operations that would inhibit the possibility of making emergency calls or conducting other emergency, safety related, or vital functions.

Although the example above refers to an automotive related remote environment and text characters, it should be appreciated that embodiments of the present invention may extend to numerous different types of input options (e.g., touch inputs, gesture inputs, voice inputs, etc.) and numerous different types of remote environments. For example, embodiments of the present invention can be utilized to disable specific touch screen areas to prevent certain applications from being launched, or prevent accidental touch events for numerous different scenarios associated with different contexts. In some example embodiments, if the mobile terminal is a touch based device, but the head unit is non-touch, the head unit may black list the touch input on the mobile device entirely. In other example embodiments, voice inputs may be prevented from being used when music is playing. For example, if the mobile terminal currently has the music player in the foreground, the mobile terminal can ask the car head unit to black list voice input or perhaps specific voice input phrases such as “email” or “text message” can be disabled. Additionally, embodiments may be utilized to prevent specific gestures (input either through a touch interface or through a camera interface). For example, if the car head unit detects that the car is in motion, the car head unit may ask the mobile terminal to black list any gesture which requires two hands and the mobile device can display a message alerting the driver that two handed gestures are disabled while the user is driving.

Accordingly, embodiments of the present invention may provide for improved interoperability between devices such that the devices can provide cooperative enablement (and corresponding disablement) for certain user input options. Thus, for example, some embodiments may enable the use of applications or services associated with one device to enhance the provision of services on another device (e.g., like the speller functionality enhancement described above). Meanwhile, other embodiments may enable the reduction of availability of some services or applications based on the context of the devices in communication with each other. In either case, cooperation between at least two devices can be used to impact the user input options available at each respective device. Moreover, unlike previous technologies that were typically limited to a specific input type (e.g., text character inputs), embodiments of the present invention apply to multiple input option classes.

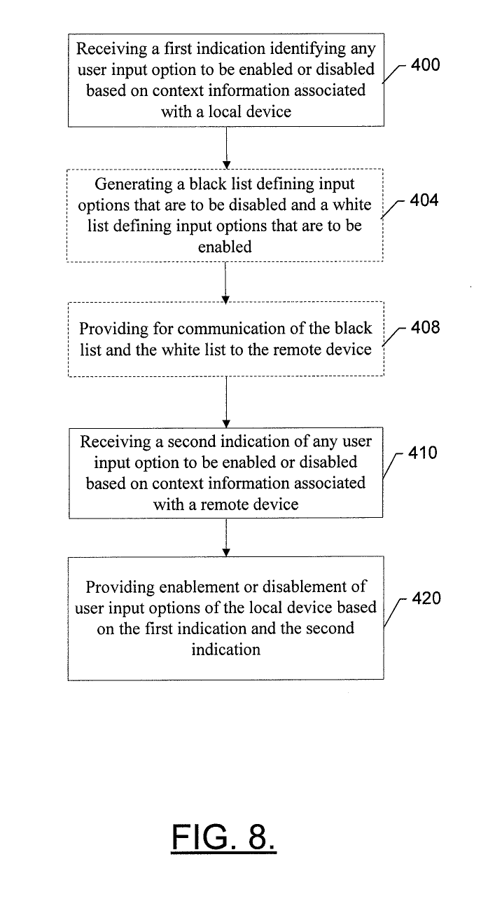

FIG. 8 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method for providing cooperative enablement of user input options, as shown in FIG. 8, includes receiving a first indication identifying any user input option to be enabled or disabled based on context information associated with a local device at operation 400, receiving a second indication of any user input option to be enabled or disabled based on context information associated with a remote device at operation 410, and providing enablement or disablement of user input options of the local device based on the first indication and the second indication at operation 420. In some embodiments, the local device may be mobile terminal 10 described above and the remote device may be the second communication device 20. However, in an alternative embodiment, the second communication device 20 may act as the local device and the mobile terminal 10 may act as the remote device and the method is equally applicable.

In some embodiments, certain ones of the operations above may be modified or further amplified as described below. Furthermore, in some embodiments, additional optional operations may be included, some examples of which are shown in dashed lines in FIG. 8. Modifications or amplifications to the operations above may be performed in any order and in any combination. In this regard, for example, the method may further include generating a black list defining input options that are to be disabled and a white list defining input options that are to be enabled at operation 404 and providing for communication of the black list and the white list to the remote device at operation 408. In an example embodiment, receiving the first or second indication may include receiving an indication of respective user input options to be enabled or disabled for each of a plurality of different user input option classes. In some cases, receiving the indication of respective user input options to be enabled or disabled for each of the plurality of different user input option classes may include receiving an indication for one or more of classes including key inputs, touch inputs, touch gestures, visual gestures, and voice inputs. In an example embodiment, receiving the first indication or receiving the second indication may include receiving the first or second indication in response to a change in context of a respective one of the local device or the remote device. In some embodiments, providing enablement or disablement of user input options of the local device based on the first indication and the second indication may include utilizing an application at the local device to modify user input options available at the remote device or limiting user input options available at the local device based on operational restrictions applicable to the context of the remote device.

In an example embodiment, an apparatus for performing the method of FIG. 8 above may comprise a processor (e.g., the processor 70) configured to perform some or each of the operations (400-420) described above. The processor may, for example, be configured to perform the operations (400-420) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-420 may comprise, for example, the processor 70, respective ones of the context analyzer 80 and the user input option manager 82, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least perform:
receiving a first indication identifying any user input option to be enabled or disabled based on context information associated with a local device;
receiving a second indication of any user input option to be enabled or disabled based on context information associated with a remote device; and
providing enablement or disablement of user input options of the local device based on the first indication and the second indication.

2. The apparatus of claim 1, wherein the memory and computer program code are configured to, with the processor, cause the apparatus to generate a black list defining input options that are to be disabled and a white list defining input options that are to be enabled and to provide for communication of the black list and the white list to the remote device.

3. The apparatus of claim 2, wherein the memory and computer program code are configured to, with the processor, cause the apparatus to provide for communication of the black list and the white list to the remote device.

4. The apparatus of claim 1, wherein the memory and computer program code are configured to, with the processor, cause the apparatus to receive an indication of respective user input options to be enabled or disabled for each of a plurality of different user input option classes.

5. The apparatus of claim 4, wherein the memory and computer program code are configured to, with the processor, cause the apparatus to receive the indication of respective user input options to be enabled or disabled for each of the plurality of different user input option classes by receiving an indication for one or more of classes including key inputs, touch inputs, touch gestures, visual gestures, and voice inputs.

6. The apparatus of claim 1, wherein the memory and computer program code are configured to, with the processor, cause the apparatus to receive the first indication and receive the second indication in response to a change in context of a respective one of the local device or the remote device.

7. The apparatus of claim 1, wherein the memory and computer program code are configured to, with the processor, cause the apparatus to provide enablement or disablement of user input options of the local device based on the first indication and the second indication by utilizing an application at the local device to modify user input options available at the remote device.

8. The apparatus of claim 1, wherein the memory and computer program code are configured to, with the processor, cause the apparatus to provide enablement or disablement of user input options of the local device based on the first indication and the second indication by limiting user input options available at the local device based on operational restrictions applicable to the context of the remote device.

9. A method comprising:
receiving a first indication identifying any user input option to be enabled or disabled based on context information associated with a local device;
receiving a second indication of any user input option to be enabled or disabled based on context information associated with a remote device; and
providing enablement or disablement of user input options of the local device based on the first indication and the second indication.

10. The method of claim 9, further comprising generating a black list defining input options that are to be disabled and a white list defining input options that are to be enabled.

11. The method of claim 10, further comprising providing for communication of the black list and the white list to the remote device.

12. The method of claim 9, wherein receiving the first indication comprises receiving an indication of respective user input options to be enabled or disabled for each of a plurality of different user input option classes.

13. The method of claim 12, wherein receiving the indication of respective user input options to be enabled or disabled for each of the plurality of different user input option classes comprises receiving an indication for one or more of classes including key inputs, touch inputs, touch gestures, visual gestures, and voice inputs.

14. The method of claim 9, wherein receiving the first indication and receiving the second indication comprises receiving the first or second indication in response to a change in context of a respective one of the local device or the remote device.

15. The method of claim 9, wherein providing enablement or disablement of user input options of the local device based on the first indication and the second indication comprises utilizing an application at the local device to modify user input options available at the remote device.

16. The method of claim 9, wherein providing enablement or disablement of user input options of the local device based on the first indication and the second indication comprises limiting user input options available at the local device based on operational restrictions applicable to the context of the remote device.

17. A computer program product comprising at least one computer-readable storage medium having computer-executable program code portions stored therein, the computer-executable program code portions comprising:
program code instructions for receiving a first indication identifying any user input option to be enabled or disabled based on context information associated with a local device;
program code instructions for receiving a second indication of any user input option to be enabled or disabled based on context information associated with a remote device; and
program code instructions for providing enablement or disablement of user input options of the local device based on the first indication and the second indication.

18. The computer program product of claim 17, further comprising program code instructions for generating a black list defining input options that are to be disabled and a white list defining input options that are to be enabled and program code instructions for providing for communication of the black list and the white list to the remote device.

19. The computer program product of claim 17, wherein program code instructions for receiving the first indication include instructions for receiving an indication of respective user input options to be enabled or disabled for each of a plurality of different user input option classes, the indication being for one or more of classes including key inputs, touch inputs, touch gestures, visual gestures, and voice inputs.

20. The computer program product of claim 17, wherein program code instructions for receiving the first indication and receiving the second indication include instructions for receiving the first or second indication in response to a change in context of a respective one of the local device or the remote device.
